(19) United States
(12) Patent Application Publication
(10) Pub. No.: US 2006/0288270 A1
(43) Pub. Date: Dec. 21, 2006

(54) Automated presentation layer generation

(75) Inventors: Suraj Gaurav, Issaquah, WA (US); Fredda Cole, Redmond, WA (US); Mathrubootham Janakiraman, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/158,181

(22) Filed: Jun. 21, 2005

(51) Int. Cl. G06F 17/24

(52) U.S. Cl. 715/506

(57) ABSTRACT

systems and methods of automatically generating user interface forms (e.g., templates), from messages associated with Schemas, via employing a normalizer component, which normalizes a schema into a hierarchy of objects containing complex schema nodes, and a mapping component that maps the nodes to user interface (UI) controls. As such, a user's interaction with a business process via a presentation layer can be facilitated when such presentation layer can be automatically generated.

### BACKGROUND

The evolution of computers and networking technologies from high-cost, low-performance data processing systems to low-cost, high-performance communication, problem solving and entertainment systems has provided a cost-effective and time saving means to lessen the burden of performing every day tasks such as correspondence, bill paying, shopping, budgeting and information gathering. For example, a computing system interfaced to the Internet, via wire or wireless technology, can provide a user with a channel for nearly instantaneous access to a wealth of information from a repository of web sites and servers located around the world, at the user's fingertips.

In particular, in business-to-business application environments, message processing and routing is of paramount importance. For example, integration brokers can be implemented to facilitate bi-directional communication between such applications, and are often employed to process millions of messages per day. Large messages require rapid and efficient processing. Also, modifying messages on an individual basis can be time-consuming and tedious.

At the same time, message repair applications typically require rich presentation layers, to facilitate user interaction therewith. For example, in an environment of the Society for Worldwide Interbank Financial Telecommunication (SWIFT), several hundred SWIFT schemas can exist. Accordingly, manually creating user interface (UI) control that is specific to each schema can be a challenging task. Additionally, SWIFT schemas undergo periodic revisions and can be changed in a span of several months, thus further complicating the arduous task of manually creating UI controls that are specific to the schemas.

Moreover, during a message repair often times a plurality of users are requested to provide inputs. Such users may not necessarily be well skilled in computers, and hence a presentation layer with a poor user interface can significantly impede their related activities. For example, when a correction of message contents received from other systems are required, and such message is to be sent to SWIFT, the user should typically be able to readily view content information in a rich graphic display, and readily provide required corrective action. Similar scenarios exist for entry, verification and approval of messages. Thus, manually developing a screen/form for such scenarios can pose a significant challenge that can lead to inaccuracies and inefficiencies.

Therefore, there is a need to overcome the aforementioned exemplary deficiencies associated with conventional systems and devices.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention provides for systems and methods of automatically generating user interface forms (e.g., templates), from messages associated with Schemas, via employing a normalizer component that normalizes a schema into a hierarchy of objects containing complex schema nodes, and a mapping component that maps the nodes to user interface (UI) controls. Such automatic generation of forms can facilitate message repair, wherein a user interacts with a message repair processing system, without typically requiring custom made hand developed template forms. Moreover, a user's interaction with a business process via a presentation layer can be facilitated when such presentation layer can be automatically generated.

In a related aspect and to supply an automatic form generation, initially an XSD (XML Schema Definition) can be divided into a plurality of nodes, such as: a Complex node, a Choice node, a Simple node, and an Enumeration node. For example, the Complex node would map to a complex element in the schema, a Choice node would map to a choice node in the schema, a Simple node would map to a leaf level node in the schema, which is not an enumeration and may have length restrictions, and an Enumeration node would map to a leaf level node that is an enumeration. A palette of UI controls can then be supplied, and the nodes mapped thereto. Controls associated with each of the UI nodes can then generate an abstract presentation language (e.g., InfoPath™).

According to a further aspect, the automatically generated form(s) can be employed for repairing a message, verifying a message that has been repaired, approving a message that has been verified, and entering a message. For example, in context of the Society for Worldwide Interbank Financial Telecommunication (SWIFT), validation errors can be collected, with the message saved in a canonical format and sent to a back end system that allows users to collaborate during message repair process. As such, associated presentation layers can be automatically generated for the entire suite of SWIFT schemas, thus mitigating manual activities and labor and increase efficiency. Hence, message repair for messages that fail parsing, eXtensible Mark up Language (XML) validation and/or network rule validation, can be facilitated via employing a presentation layer that is generated automatically and built around rich form templates that are based on XML.

An exemplary methodology of automatically creating the forms include “template-izing” a form solution in conjunction with developing a palette of UI controls that can emit an abstract presentation language. Next, normalizing of the document schema and mapping data nodes to the UI controls occurs followed by code emission. This can be readily applied to a data definition language at the front-end, such as XML Schema Definition (XSD), a document type definition (DTD), Database Schemas and the like. Likewise, the subject invention can be tuned to a back-end form technology, such as Html forms and like. Typically, a form can include a set of 61 files, wherein a file is generated from a template that is a file serving as the base for artifact generation. Two types of templates can be employed, namely: a static template and a dynamic template. The static template in general contains static content, and can contain either binary or text data.

Similarly, the dynamic template can contain text data along with one or more micro templates. Such dynamic templates can consist of text data and micro-templates that are replaceable data entries with values are computed during form generation and replaced in the dynamic template. For example, a micro-template can be a name of the document schema that is inputted from the schema, and another micro-template can include a value for the template. Accordingly, an envelope schema can be generated based on an associated template. Such envelope schema can then be normalized in to a model that contains a plurality of nodes; such as the Complex node, Choice node, Simple node, and an Enumeration node. Hence, regardless of the schema and a field or data type, a schema can be broken in to a tree of objects, for example four objects, such that a complex node will map to a complex element schema, a choice node that will map to a choice node in the schema—(data entry can occur in form of a text box, or in form of a drop down control, each having a separate node namely; the Simple node and the Enumeration node.) Thus, by observing the XSD an object model can be built thereupon, which facilitates automatic form generation.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a schematic interaction between users and a business process via employing automatically generated forms in accordance with an aspect of the subject invention.

FIG. 2 illustrates a block diagram for a form generation in accordance with an aspect of the subject invention.

FIG. 3 illustrates a block diagram of user interface controls that facilitate automatic generation of forms in accordance with an aspect of the subject invention.

FIGS. 4a & 4b illustrate a list of static templates and dynamic templates that facilitate automatic form generation in accordance with an aspect of the subject invention.

FIG. 5 illustrates a sample form that is automatically generated in accordance with an aspect of the subject invention.

FIG. 6 illustrates a general block diagram of an over all architecture for a SWIFT message repair solution that employs an automatic form generation in accordance with an aspect of the subject invention.

FIG. 7 illustrates an exemplary methodology of automatic creation of forms in accordance with an aspect of the subject invention.

FIG. 8 illustrates an exemplary structure of an automatic form generator that employs an artificial intelligence (AI) component, in accordance with an aspect of the subject invention.

FIG. 9 illustrates a brief, general description of a suitable computing environment, wherein the various aspects of the subject invention can be implemented.

FIG. 10 illustrates a client—server system that can employ an automatic layer presentation layer generator according to one aspect of the subject invention.

Appendix A is an exemplary template of form view in connection with particular aspects of the invention, and this appendix is considered part of the detailed description of this application.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention can be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

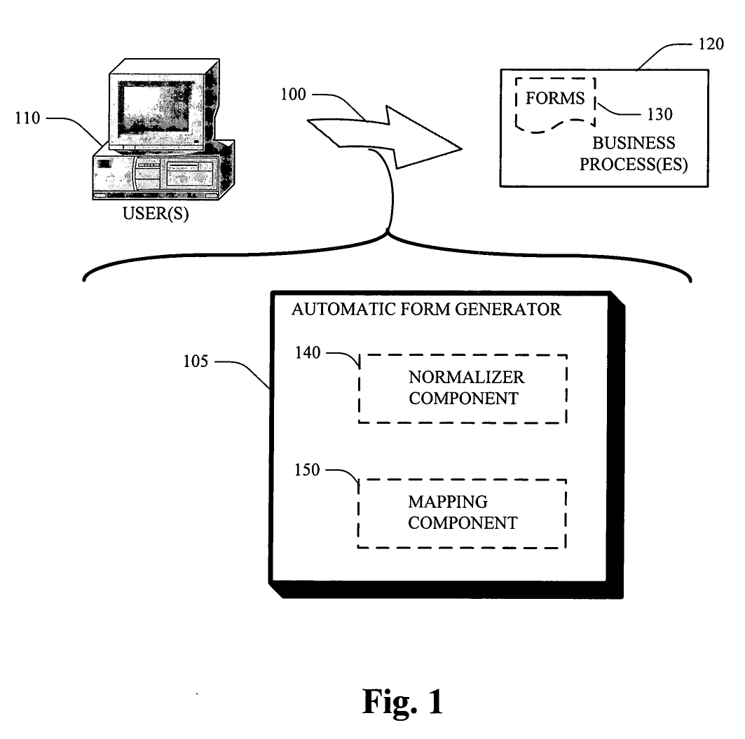

Referring initially to FIG. 1, there is illustrated an interaction 100 between users 110 and a business process 120, via a plurality of forms 130 that are automatically generated by employing an automatic form generator 105. Such automatic form generator 105 includes a normalizer component 140 and a mapping component 150, wherein the normalizer component 140 can normalize a schema inputted thereto, into hierarchy of objects that contain complex schema nodes. Moreover, the mapping component 150 can map such nodes to a user interface (UI) controls. In one particular aspect, the business process 120 can be an integration broker common in business-to-business (B2B) and enterprise application integration (EAI) applications. The integration brokers can receive messages or data packets in widely varied formats, from various sources, via various transport mechanisms. Pre-configured business rules act on these messages and can trigger other actions. Business rules and validation logic are often expressed in specific forms, such as, for example, extensible markup language (XML) Schema. The business process 120 can employ a custom XML Schema definition language, wherein messages can then be routed to other destinations through specified transport mechanisms. The messages can optionally undergo translation into formats suitable for such destinations, wherein typically a translation process need not alter the message content, and data in some portions of the message can be altered via a transformation process based on pre-configured rules that are specific to a destination. A single incoming message can thus be broadcast to multiple destinations in a message format acceptable to each destination to which it is broadcast.

For example, in context of the Society for Worldwide Interbank Financial Telecommunication (SWIFT), the automatically generated form(s) can be employed for repairing a message, verifying a message that has been repaired, approving a message that has been verified, and entering a message. Thus, validation errors can be collected, with the message converted and saved in a canonical format (e.g., canonical XML) and sent to a back end system (not shown) that allows users to collaborate during message repair process. Converting such messages to XML format allows them to be manipulated effectively before they are routed to destination systems and/or applications. Moreover, verifications can be implemented to check and ensure that the data in the message conforms to certain format and/or business rules. As such, associated presentation layers can be automatically generated for the entire suite of SWIFT schemas, thus mitigating manual activities and labor and increase efficiency. Hence, message repair for messages that fail parsing, eXtensible Mark up Language (XML) validation and/or network rule validation, can be facilitated via employing a presentation layer that is generated automatically and built around rich form templates that are based on XML.

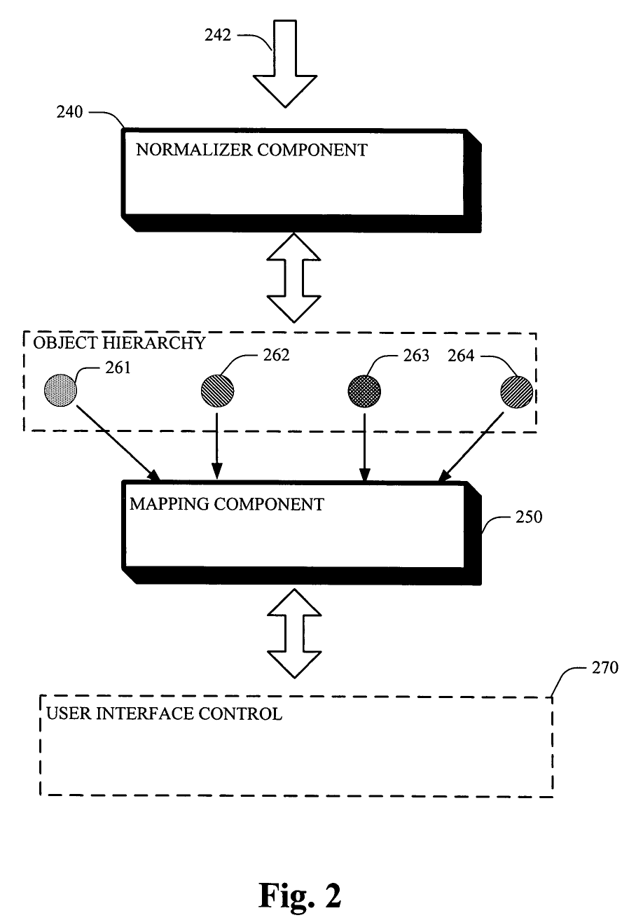

FIG. 2 illustrates a block diagram of a normalizer component 240 and a mapping component 250, in accordance with an aspect of the subject invention. The normalizer component 240 normalizes a schema 242 inputted thereto, into a hierarchy of objects. The schema 242 can be a definition of an external message that has been reduced to a schema. Such schema 242 can define the format of the message and various fields as part thereof. For example, the message can be reorganized to a plurality of segments, wherein each segment can further include one or more fields. In addition, fields can comprise complex data types, simple data types, or a combination thereof. Additionally, fields can be optional, and the fields, components, and the like can be associated with one or more enumeration tables that can define constant values that can be imported and/or selected.

Typically, a form can include a set of 61 files, wherein a file is generated from a template that is a file serving as the base for artifact generation. Two types of templates can be employed, namely: a static template and a dynamic template. The static template in general contains static content, and can contain either binary or text data. Similarly, the dynamic template can contain text data along with one or more micro templates. Such dynamic templates can consist of text data and micro-templates that are replaceable data entries, whose values are computed during form generation and replaced in the dynamic template. For example, a micro-template can be a name of the document schema that is inputted from the schema, and another micro-template can include a value for the template. Accordingly, an envelope schema can be generated based on a corresponding template. The normalizer component 240 can normalize such envelope schema into a model object that contains a plurality of object nodes; such as the Complex node 261, Choice node 262, Simple node 263, and an Enumeration node 264. Hence, regardless of the schema and a field or data type, a schema can be broken in to a tree of objects, for example four objects that are closely represented in the XSD, such that a Complex node 261 will map to a complex element in the schema, and a Choice node 262 will map to a choice node in the schema, and the like. Thus, by observing the XSD an object model can be built thereupon, which facilitates form generation.

As explained, the four object s are closely represented in the XSD, for example the XSD can contain a complex type that maps to the Complex node 261 in a data structure in the XSD. At the same time, data entry can occur in form of a text box, or in form of a drop down control, each having a separate node namely; the Simple node 263 and the Enumeration node 264. The Simple node 263 can map to a leaf level node in the schema, which is not an enumeration and may have length restrictions, and the Enumeration node 264 can map to a leaf level node that is an enumeration.

The mapping component 250 can then map each of the nodes 261, 262, 263, and 264 to the UI controls 270. The UI controls 270 can be bound to elements of the schema, wherein at an end of the form emission process, such UI controls can be called upon to generate abstract presentation language code. It is to be appreciated that a logic associated with such UI controls can be tuned to generate HTML from specific codes.

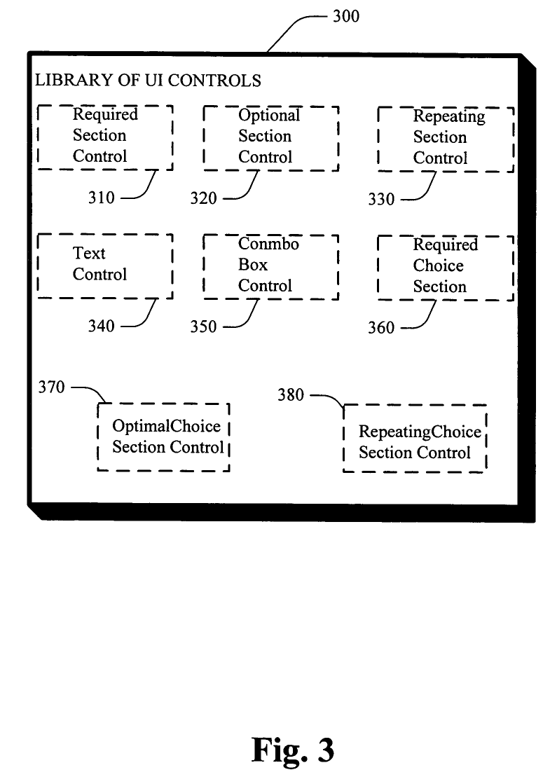

FIG. 3 illustrates a schematic block diagram for a library of UI controls 300. As illustrated, such library includes a plurality of controls namely a RequiredSection control 310, an OptionalSection control 320, a RepeatingSection control 330, a TextControl 340, a ComboBoxControl 350, a RequiredChoiceSection control 360, an OptionalChoiceSection control 370, and a RepeatingChoiceSection control 380. The RequiredSection control 310 is a container control, which can further contain other container controls or atomic controls. During form generation in accordance with an exemplary aspect of the subject invention, there can exist one such construct for each ComplexNode, with min=max=1. Likewise, OptionalSection control 320 is a container control that can contain other container controls or atomic controls. During form generation, there is one such construct for each ComplexNode, with min=0, max=1.

Additionally, RepeatingSection control 330 is a container control, which can contain other container controls or atomic controls. During form generation, there is one such construct for each ComplexNode, with max>1. Likewise, TextControl 340 is an atomic control, and during form generation, there is one such construct for each SimpleNode. In some cases, data for a SimpleNode and associated siblings can be conditionally dependent on one another. As such, the control generates code for such conditional rules, and depending on cardinality of the node, it can be wrapped in one of the above container controls. Furthermore, ComboBoxControl 350 is an atomic control, and there can exist one such construct for each Enumeration Node, as discussed infra. Depending on cardinality of the node, it can be wrapped in one of the above container controls.

Additionally, RequiredChoiceSection control 310, is a container control that can contain other container controls or atomic controls. During form generation, there typically exists one such construct for each ChoiceNode, with min=max=1. Similarly, OptionalChoiceSection control 320 is a container control, which can contain other container controls or atomic controls. In general, during form generation, there is one such construct for each ChoiceNode, with min=0, max=1. Also, the RepeatingChoiceSection control 380 is a container control, which can contain other container controls or atomic controls. During form generation, there exists one such construct for each ChoiceNode, with max>1.

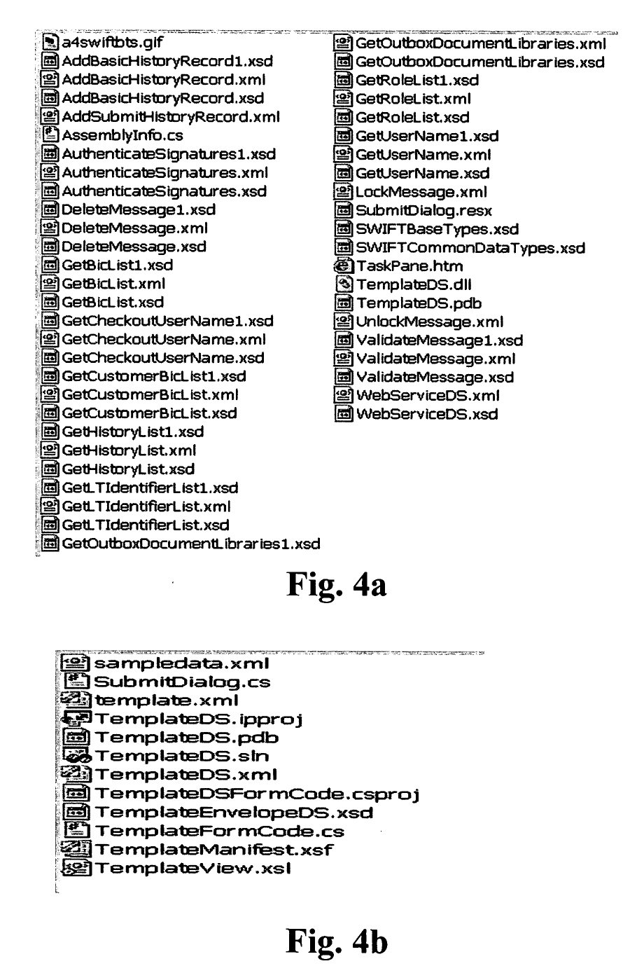

FIGS. 4a & 4b illustrate a list of static templates and dynamic templates. Typically and in accordance with the subject invention, two types of templates can be employed, namely: a static template and a dynamic template. As illustrated in FIG. 4a, the static template in general contains static content, and can contain either binary or text data. For example, during form generation, static templates can be copied from one location to another. Similarly and as illustrated in list of FIG. 4b, the dynamic template can contain text data along with one or more micro templates. Such dynamic templates can consist of text data and micro-templates that are replaceable data entries whose values are computed during form generation and replaced in the dynamic template. For example, a micro-template can be a name of the document schema that is inputted from the schema, and another micro-template can include a value for the template. Accordingly, an envelope schema can be generated based on an associated template. Appendix A illustrates an exemplary template for form view in connection with particular aspects of the invention, and this appendix is considered part of the detailed description of this application.

In accordance with an aspect of the subject invention, a list of micro-templates with a description thereof includes:
1. IFG_DocumentSchemaName_IFG—Name of the document schema
2. IFG_EnvelopeSchemaNS_IFG—Envelope schema namespace
3. IFG_DocumentSchemaNS_IFG—Document schema namespace
4. IFG_MessageType_IFG—Message type
5. IFG_Category_IFG—Category of document schema
6. IFG_EnvelopeSchemaRootNodeName_IFG—Envelope schema root node name
7. IFG_DocumentSchemaRootNodeName_IFG—Document schema root node name
8. IFG_DocumentSchemaBodyNodeName_IFG—Document schema body node name
9. IFG_View_IFG—Infopath view
10. IFG_XmiToEdit_IFG—Infopath manifest
11. IFG_SampleData_IFG—Sample instance of form data
12. IFG_Template_IFG—Sample template data
13. IFG_InsertMenu_IFG—Insert menu area
14. IFG_ReplaceMenu_IFG—Replace menu area
15. IFG_ContextMenu_IFG—Context menu area
16. IFG_RuleSets_IFG—Rule sets contained in manifest
17. IFG_DomEventHandlers_IFG—Event handlers that respond to DOM events

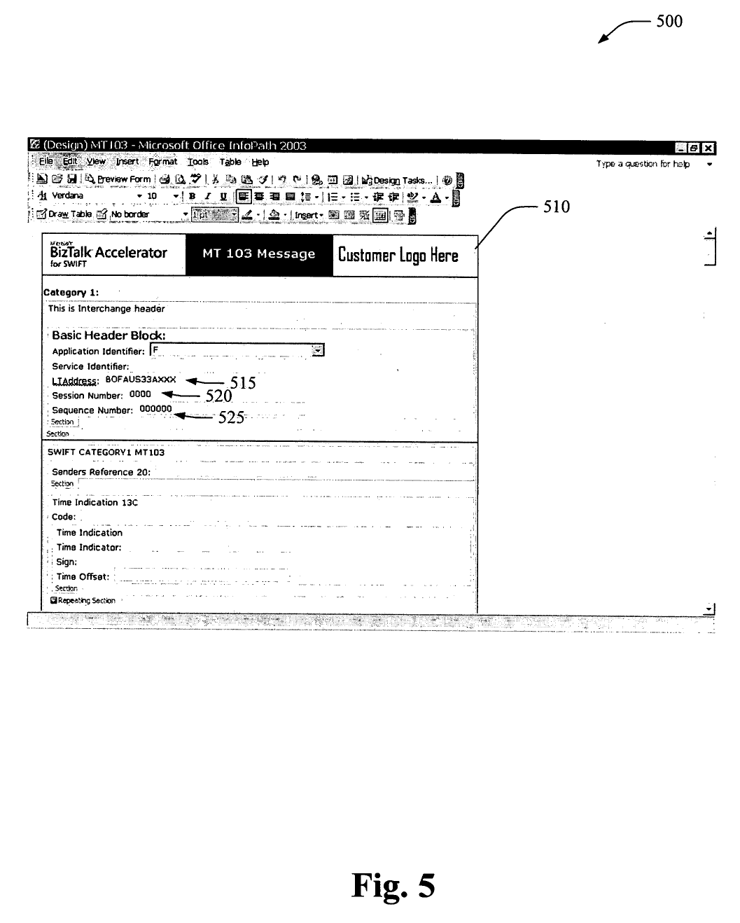

Referring now to FIG. 5 there is illustrated a sample form that is generated automatically in accordance with an aspect of the subject invention. The exemplary form 500 can be employed for SWIFT related message applications and repair services. An area 510 has been provided for a financial institution logo on the header line of the form. Such basic header exists for all messages, and can have the same format for input and output messages. At the same time, the information contained in the basic header is relative to the sender when the message is input to the SWIFT, yet relative to the receiver when the same message is output from SWIFT. The LTAddress 515 can indicate logical terminal address of an institution, in a role as a sender or receiver, for example. In addition, the Session Number 520 and the Sequence Number 525 are typically protected. Such can be filled in on a message from SWIFT and empty on a message to SWIFT, as they are completed by the SWIFT Alliance Access.

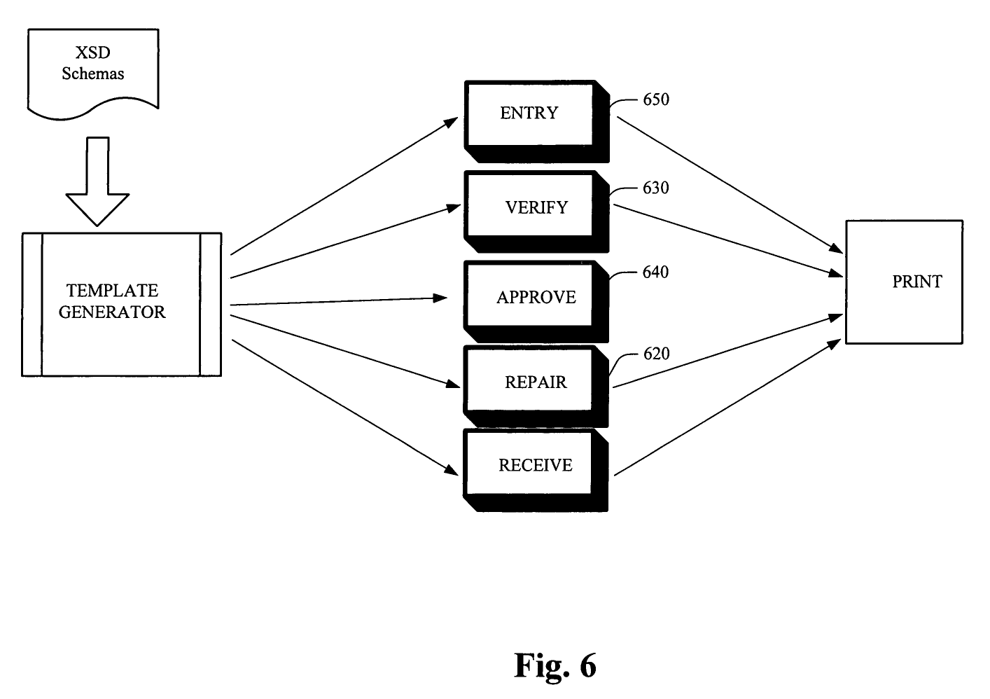

FIG. 6 illustrates a general block diagram of an over all architecture for a SWIFT message repair solution to repair messages that fail parsing, XML validation, or network rule validation. By employing an abstract presentation language (e.g., InfoPath™) as a vehicle for an automatic generation of templates, as described in detail supra, the template generator 610 can typically mitigate a requirement to individually program each template. Thus, for each message type a single template can be generated. In addition, the forms can be digitally signed when submitted, and a chain of signatures generated for every submission associated with the message.

The automatically generated form(s) can be employed for repairing 620 a message, verifying 630 a message that has been repaired, approving 640 a message that has been verified, and entering 650 a message. Thus, validation errors can be collected, with the message converted and saved in a canonical format (e.g., canonical XML) and sent to a back end system.

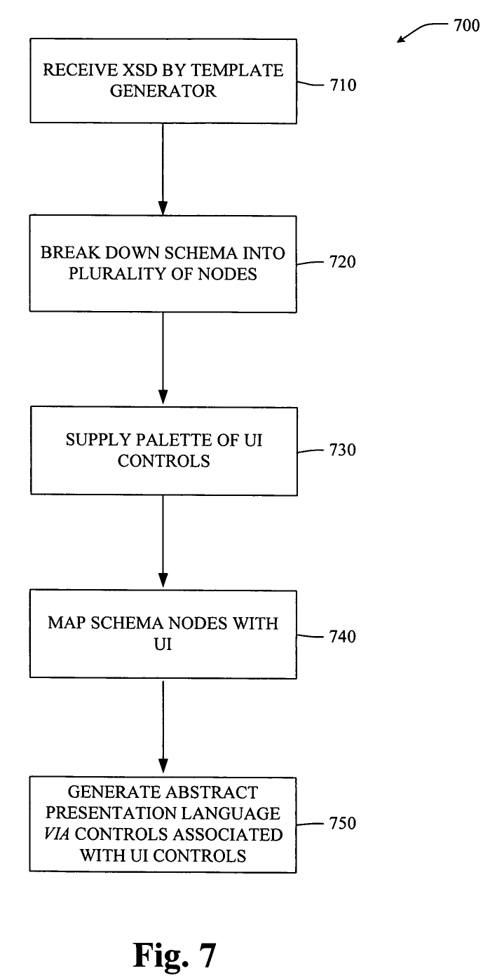

An exemplary methodology 700 of automatically creating the forms in accordance with an aspect of the subject invention is illustrated in FIG. 7. While the exemplary method is illustrated and described herein as a series of blocks representative of various events and/or acts, the present invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention may be implemented in association with the method illustrated and described herein, as well as in association with other systems and apparatus not illustrated or described.

Initially and at 710, an XSD (XML Schema Definition) can be received by a template generator of the subject invention. Next, and at 720 the schema can be broken down into a plurality of nodes, such as: a Complex node, a Choice node, a Simple node, and an Enumeration node. Subsequently, and at 730 a palette of UI controls can then be supplied. At 740, a mapping occurs wherein the Complex node would map to a complex element in the schema, a Choice node would map to a choice node in the schema, a Simple node would map to a leaf level node in the schema, which is not an enumeration and may have length restrictions, and an Enumeration node would map to a leaf level node that is an enumeration. Controls associated with each of the UI nodes can then generate an abstract presentation language (e.g., InfoPath™), at 750.

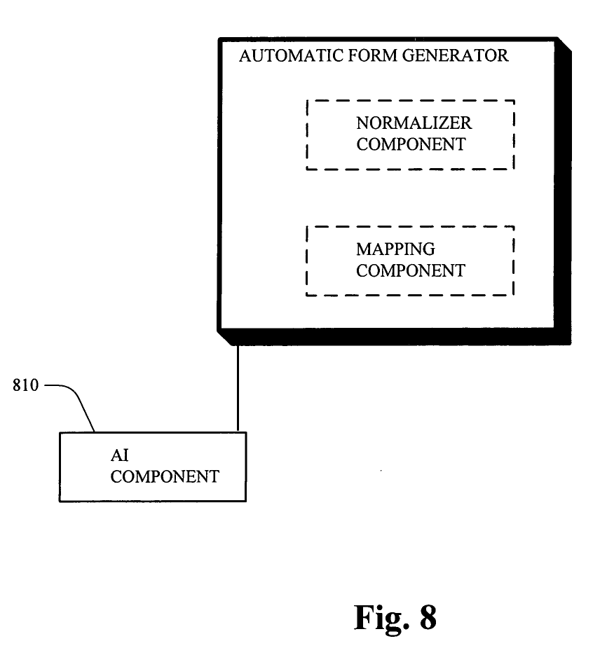

FIG. 8 illustrates an exemplary structure of an automatic form generator that employs an artificial intelligence (AI) component 810, in accordance with an aspect of the subject invention. For example, various artificial intelligence component(s) 810 can be employed in conjunction with inferring the type of form to be generated, as well as other aspects of the subject invention. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The subject invention (e.g., in connection with various aspects of the automatic form generation) can employ various artificial intelligence based schemes for carrying out various aspects thereof. For example, a process for determining which forms to be generated, and type of message corrective action can be facilitated via an automatic classification system and process. Such classification can employ a probabilistic and/or statistical-based analysis (e.g., factoring into the analysis utilities and costs) to prognose or infer an action that is desired to be automatically performed. For example, a support vector machine (SVM) classifier can be employed. A classifier is a function that maps an input attribute vector, x=(x1, x2, x3, x4, xn), to a confidence that the input belongs to a class—that is, f(x)=confidence(class). Other classification approaches include Bayesian networks, decision trees, and probabilistic classification models providing different patterns of independence can be employed. Classification as used herein also is inclusive of statistical regression that is utilized to develop models of priority. As will be readily appreciated from the subject specification, the subject invention can employ classifiers that are explicitly trained (e.g., via a generic training data) as well as implicitly trained (e.g., via observing system behavior, receiving extrinsic information) so that the classifier(s) is used to automatically determine according to a selected criteria type of corrective action and/or automatic from generation. For example, with respect to SVM's it is to be appreciated that other classifier models may also be utilized such as Naive Bayes, Bayes Net, decision tree and other learning models—SVM's are configured via a learning or training phase within a classifier constructor and feature selection module.

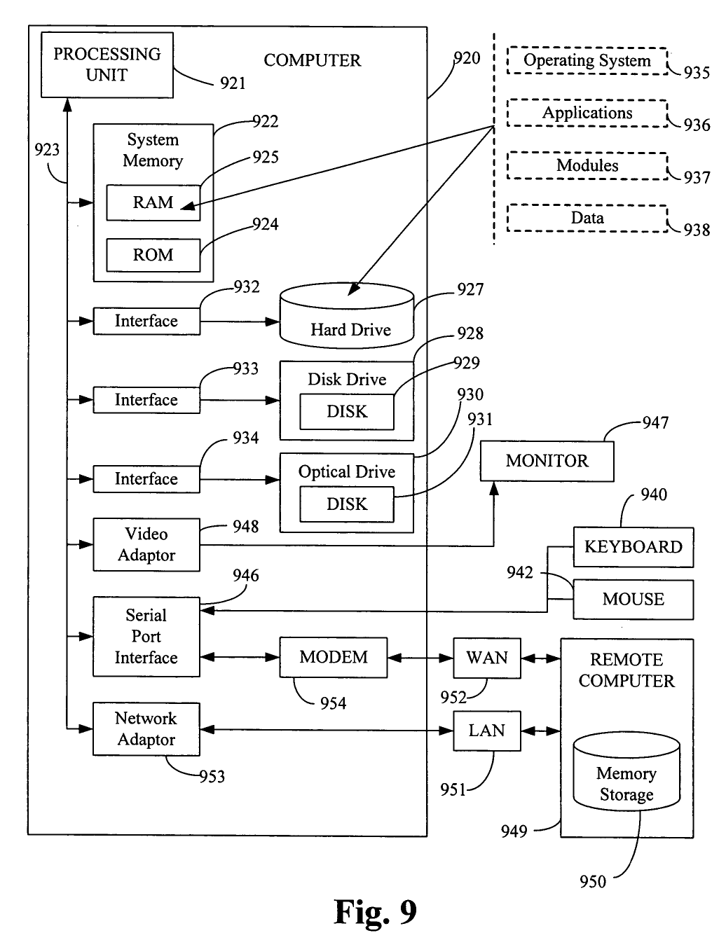

Referring now to FIG. 9, a brief, general description of a suitable computing environment is illustrated wherein the various aspects of the subject invention can be implemented. While the invention has been described above in the general context of computer-executable instructions of a computer program that runs on a computer and/or computers, those skilled in the art will recognize that the invention can also be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary environment includes a computer 920, including a processing unit 921, a system memory 922, and a system bus 923 that couples various system components including the system memory to the processing unit 921. The processing unit 921 can be any of various commercially available processors. Dual microprocessors and other multi-processor architectures also can be used as the processing unit 921.

The system bus can be any of several types of bus structure including a USB, 1394, a peripheral bus, and a local bus using any of a variety of commercially available bus architectures. The system memory may include read only memory (ROM) 924 and random access memory (RAM) 925. A basic input/output system (BIOS), containing the basic routines that help to transfer information between elements within the computer 920, such as during start-up, is stored in ROM 924.

The computer 920 further includes a hard disk drive 927, a magnetic disk drive 928, e.g., to read from or write to a removable disk 929, and an optical disk drive 930, e.g., for reading from or writing to a CD-ROM disk 931 or to read from or write to other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide nonvolatile storage of data, data structures, computer-executable instructions, etc. for the computer 920. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the subject invention. A number of program modules can be stored in the drives and RAM 925, including an operating system 935, one or more application programs 936, other program modules 937, and program data 938. The operating system 935 in the illustrated computer can be substantially any commercially available operating system.

A user can enter commands and information into the computer 920 through a keyboard 940 and a pointing device, such as a mouse 942. Other input devices (not shown) can include a microphone, a joystick, a game pad, a satellite dish, a scanner, or the like. These and other input devices are often connected to the processing unit 921 through a serial port interface 946 that is coupled to the system bus, but may be connected by other interfaces, such as a parallel port, a game port or a universal serial bus (USB). A monitor 947 or other type of display device is also connected to the system bus 923 via an interface, such as a video adapter 948. In addition to the monitor, computers typically include other peripheral output devices (not shown), such as speakers and printers.

The computer 920 can operate in a networked environment using logical connections to one or more remote computers, such as a remote computer 949. The remote computer 949 may be a workstation, a server computer, a router, a peer device or other common network node, and typically includes many or all of the elements described relative to the computer 920, although only a memory storage device 950 is illustrated in FIG. 9. The logical connections depicted in FIG. 9 may include a local area network (LAN) 951 and a wide area network (WAN) 952. Such networking environments are commonplace in offices, enterprise-wide computer networks, Intranets and the Internet.

When employed in a LAN networking environment, the computer 920 can be connected to the local network 951 through a network interface or adapter 953. When utilized in a WAN networking environment, the computer 920 generally can include a modem 954, and/or is connected to a communications server on the LAN, and/or has other means for establishing communications over the wide area network 952, such as the Internet. The modem 954, which can be internal or external, can be connected to the system bus 923 via the serial port interface 946. In a networked environment, program modules depicted relative to the computer 920, or portions thereof, can be stored in the remote memory storage device. It will be appreciated that the network connections shown are exemplary and other means of establishing a communications link between the computers can be employed.

In accordance with the practices of persons skilled in the art of computer programming, the subject invention has been described with reference to acts and symbolic representations of operations that are performed by a computer, such as the computer 920, unless otherwise indicated. Such acts and operations are sometimes referred to as being computer-executed. It will be appreciated that the acts and symbolically represented operations include the manipulation by the processing unit 921 of electrical signals representing data bits which causes a resulting transformation or reduction of the electrical signal representation, and the maintenance of data bits at memory locations in the memory system (including the system memory 922, hard drive 927, floppy disks 929, and CD-ROM 931) to thereby reconfigure or otherwise alter the computer system's operation, as well as other processing of signals. The memory locations wherein such data bits are maintained are physical locations that have particular electrical, magnetic, or optical properties corresponding to the data bits.

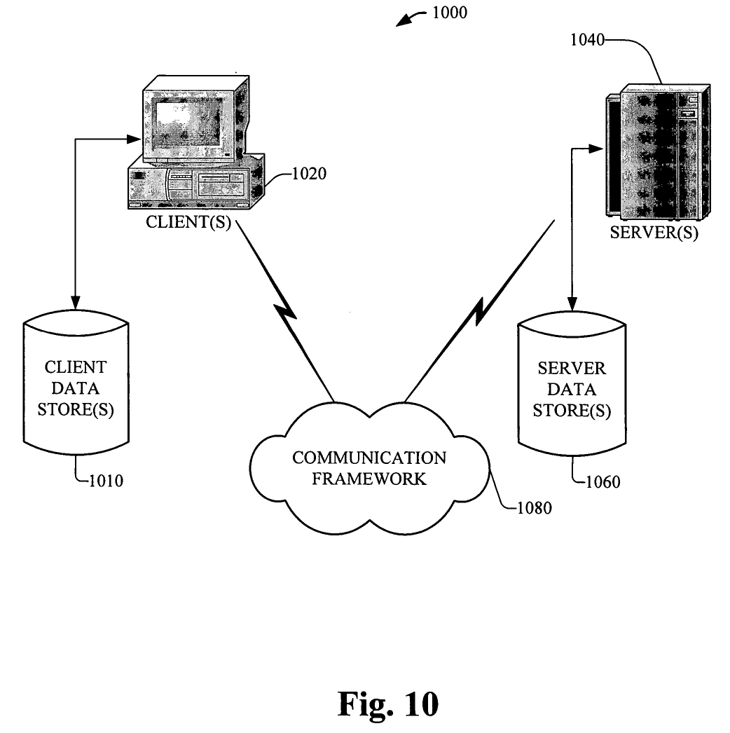

Referring now to FIG. 10, a client—server system 1000 that can employ an automatic layer presentation layer generator according to one aspect of the invention is illustrated. The client(s) 1020 can be hardware and/or software (e.g., threads, processes, computing devices). The system 1000 also includes one or more server(s) 1040. The server(s) 1040 can also be hardware and/or software (e.g., threads, processes, computing devices). For example, such servers 1040 can house threads to perform transformations by employing the invention. The client 1020 and the server 1040 can communicate, between two or more computer processes. As illustrated, the system 1000 includes a communication framework 1080 that can facilitate communications between the client(s) 1020 and the server(s) 1040. The client(s) 1020 is operationally connected to one or more client data store(s) 1010 that can store information local to the client(s) 1020. Moreover, client 1020 can access and update databases 1060 located on a server computer 1040 running a server process. In one aspect of the invention, the communication frame work 1080 can be the internet, with the client process being a Web browser and the server process being a Web server. As such, a typical client 1020 can be a general purpose computer, such as a conventional personal computer having a central processing unit (CPU), system memory a modem or network card for connecting the personal computer to the Internet, and a display as well as other components such as a keyboard, mouse, and the like. Likewise a typical server 1040 can be university or corporate mainframe computers, or dedicated workstations, and the like.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. Furthermore, to the extent that the terms “includes”, “including”, “has”, “having”, and variants thereof are used in either the detailed description or the claims, these terms are intended to be inclusive in a manner similar to the term “comprising.” Appendix A is an exemplary template for form view in connection with particular aspects of the invention, and this appendix is considered part of the detailed description of this application.

APPENDIX A
Template for form View
Micro-templates have been highlighted in bold.

```
<?xml version=“1.0” encoding=“UTF-8”?>
<xsl:stylesheet version=“1.0” xmlns:xsi=“http://www.w3.org/2001/XMLSchema-instance”
xmlns:b=“http://schemas.microsoft.com/BizTalk/2003” xmlns:ns1=“##IFG—EnvelopeSchemaNS—IFG##”
xmlns:ns0=“##IFG—DocumentSchemaNS—IFG##”
xmlns:ns2=“http://schemas.microsoft.com/BizTalk/Solutions/FinancialServices/SWIFT/BaseTypes”
xmlns:a4s0=“http://schemas.microsoft.com/BizTalk/Solutions/FinancialSerices/SWIFT/DataTypes”
xmlns:schemaEditorExtension=“http://schemas.microsoft.com/BizTalk/2003/SchemaEditorExtensions”
xmlns:my=“http://schemas.microsoft.com/office/infopath/2003/myXSD/2004-06-29T20-04-55”
xmlns:xd=“http://schemas.microsoft.com/office/infopath/2003” xmlns:xsl=“http://www.w3.org/1999/XSL/Transform”
xmlns:msxsl=“urn:schemas-microsoft-com:xslt” xmlns:x=“urn:schemas-microsoft-com:office:excel”
xmlns:xdExtension=“http://schemas.microsoft.com/office/infopath/2003/xslt/extension”
xmlns:xdXDocument=“http://schemas.microsoft.com/office/infopath/2003/xslt/xDocument”
xmlns:xdSolution=“http://schemas.microsoft.com/office/infopath/2003/xslt/solution”
xmlns:xdFormatting=“http://schemas.microsoft.com/office/infopath/2003/xslt/formatting”
xmlns:xdImage=“http://schemas.microsoft.com/office/infopath/2003/xslt/xImage”
xmlns:xdUtil=“http://schemas.microsoft.com/office/infopath/2003/xslt/Util”
xmlns:xdMath=“http://schemas.microsoft.com/office/infopath/2003/xslt/Math”
xmlns:xdDate=“http://schemas.microsoft.com/office/infopath/2003/xslt/Date”
xmlns:sig=“http://www.w3.org/2000/09/xmldsig#”
xmlns:xdSignatureProperties=“http://schemas.microsoft.com/office/infopath/2003/SignatureProperties”>
  <xsl:output method=“html” indent=“no”/>
  <xsl:template match=“ns1:##IFG—EnvelopeSchemaRootNodeName—IFG##”>
    <html>
      <head>
        <meta http-equiv=“Content-Type” content=“text/html”></meta>
        <style controlStyle=“controlStyle”>@media screen
        { BODY{margin-left:21px:background-position:21px 0px;}
  } BODY{color:windowtext;background-color:window;layout-grid:none;}
  .xdListItem {display:inline-block;width:100%;vertical-align:text-top;}
  .xdListBox,.xdComboBox{margin:1px;}  .xdInlinePicture{margin:1px; BEHAVIOR:
url(#default#urn::xdPicture) }  .xdLinkedPicture{margin:1px; BEHAVIOR: url(#default#urn::xdPicture)
url(#default#urn::controls/Binder) }  .xdSection{border:1pt solid #FFFFFF;margin:6px 0px 6px
0px;padding:1px 1px 1px 5px;}  .xdRepeatingSection{border:1pt solid #FFFFFF;margin:6px 0px
6px 0px;padding:1px 1px 1px 5px;}  .xdBehavior_Formatting {BEHAVIOR:
url(#default#urn::controls/Binder) url(#default#Formatting);} .xdBehavior_FormattingNoBUI{BEHAVIOR:
url(#default#CalPopup) url(#default#urn::controls/Binder) url(#default#Formatting);}
  .xdExpressionBox{margin: 1px;padding:1px;word-wrap: break-word;text-overflow: ellipsis;overflow-
x:hidden;}.xdBehavior_GhostedText,.xdBehavior_GhostedTextNoBUI{BEHAVIOR: url(#default#urn::controls/Binder)
url(#default#TextField) url(#default#GhostedText);}  .xdBehavior_GTFormatting{BEHAVIOR:
url(#default#urn::controls/Binder) url(#default#Formatting) url(#default#GhostedText);}
  .xdBehavior_GTFormattingNoBUI{BEHAVIOR: url(#default#CalPopup) url(#default#urn::controls/Binder)
url(#default#Formatting) url(#default#GhostedText);}  .xdBehavior_Boolean{BEHAVIOR:
url(#default#urn::controls/Binder) url(#default#BooleanHelper);}  .xdBehavior_Select{BEHAVIOR:
url(#default#urn::controls/Binder) url(#default#SelectHelper);}  .xdRepeatingTable{BORDER-TOP-STYLE:
none; BORDER-RIGHT-STYLE: none; BORDER-LEFT-STYLE: none; BORDER-BOTTOM-STYLE: none; BORDER-
COLLAPSE: collapse; WORD-WRAP: break-word;}.xdScrollableRegion{BEHAVIOR: url(#default#ScrollableRegion);}
    .xdMaster{BEHAVIOR: url(#default#MasterHelper);}  .xdActiveX{margin:1px;
BEHAVIOR: url(#default#ActiveX);}  .xdFileAttachment{display:inline-
block;margin:1px;BEHAVIOR:url(#default#urn::xdFileAttachment);}  .xdPageBreak{display:
none;}BODY{margin-right:21px;}  .xdTextBoxRTL{display:inline-block;white-space:nowrap;text-
overflow:ellipsis;;padding:1px;margin:1px;border: 1pt solid #dcdcdc;color:windowtext;background-
color:window;overflow:hidden;text-align:right;}  .xdRichTextBoxRTL{display:inline-
block;;padding:1px;margin:1px;border: 1pt solid #dcdcdc;color:windowtext;background-color:window;overflow-
x:hidden;word-wrap:break-word;text-overflow:ellipsis;text-align:right;font-weight:normal;font-style:normal;text-
decoration:none;vertical-align:baseline;}  .xdDTTextRTL{height:100%;width:100%;margin-
left:22px;overflow:hidden;padding:0px;white-space:nowrap;} .xdDTButtonRTL{margin-right:-
21px;height:18px;width:20px;behavior: url(#default#DTPicker);} .xdTextBox{display:inline-block;white-
space:nowrap;text-overflow:ellipsis;;padding:1px;margin:1px;border: 1pt solid #dcdcdc;color:windowtext;background-
color:window;overflow:hidden;text-align:left;}  .xdRichTextBox{display:inline-
block;;padding:1px;margin:1px;border: 1pt solid #dcdcdc;color:windowtext;background-color:window;overflow-
x:hidden;word-wrap:break-word;text-overflow:ellipsis;text-align:left;font-weight:normal;font-style:normal;text-
decoration:none;vertical-align:baseline;}  .xdDTPicker{;display:inline;margin:1px;margin-bottom: 2px;border:
1pt solid #dcdcdc;color:windowtext;background-color:window;overflow:hidden;}
  .xdDTText{height:100%;width:100%;margin-right:22px;overflow:hidden;padding:0px;white-space:nowrap;}
    .xdDTButton{margin-left:−21px;height:18px;width:20px;behavior: url(#default#DTPicker);}
  .xdRepeatingTable TD {VERTICAL-ALIGN: top;}</style>
        <style tableEditor=“TableStyleRulesID”>TABLE.xdLayout TD {
  BORDER-RIGHT: medium none; BORDER-TOP: medium none; BORDER-LEFT: medium none;
BORDER-BOTTOM: medium none
}
TABLE.msoUcTable TD {
  BORDER-RIGHT: 1pt solid; BORDER-TOP: 1pt solid; BORDER-LEFT: 1pt solid; BORDER-BOTTOM: 1pt
solid
}
TABLE {
  BEHAVIOR: url (#default#urn::tables/NDTable)
}
</style>
        <style languageStyle=“languageStyle”>BODY {
  FONT-SIZE: 10pt; FONT-FAMILY: Verdana
}
TABLE {
  FONT-SIZE: 10pt; FONT-FAMILY: Verdana
}
SELECT {
  FONT-SIZE: 10pt; FONT-FAMILY: Verdana
}
.optionalPlaceholder {
  PADDING-LEFT: 20px; FONT-WEIGHT: normal; FONT-SIZE: xx-small; BEHAVIOR:
url(#default#xOptional); COLOR: #333333; FONT-STYLE: normal; FONT-FAMILY: Verdana; TEXT-DECORATION:
none
}
.langFont {
  FONT-FAMILY: Verdana
}
</style>
      </head>
      <body>
        <div>
          <table class=“xdLayout” style=“BORDER-RIGHT: medium none;
TABLE-LAYOUT: fixed; BORDER-TOP: medium none; BORDER-LEFT: medium none; WIDTH: 651px; BORDER-
BOTTOM: medium none; BORDER-COLLAPSE: collapse; WORD-WRAP: break-word” borderColor=“buttontext”
border=“1”>
            <colgroup>
              <col style=“WIDTH: 217px”></col>
              <col style=“WIDTH: 217px”></col>
              <col style=“WIDTH: 217px”></col>
            </colgroup>
            <tbody vAlign=“top”>
              <tr>
                <td style=“BORDER-RIGHT:
#000000 1pt solid; BORDER-TOP: #000000 1pt solid; BORDER-LEFT: #000000 1pt solid; BORDER-BOTTOM:
#000000 1pt solid; BACKGROUND-COLOR: #ffffff”>
                  <div>
                    <font
face=“Verdana” size=“2”>
                      <img
style=“WIDTH: 199px; HEIGHT: 60px” height=“135” src=“a4swiftbts.gif” width=“448”/>
                    </font>
                  </div>
                </td>
                <td style=“BORDER-RIGHT:
#000000 1pt solid; BORDER-TOP: #000000 1pt solid; BORDER-LEFT: #000000 1pt solid; BORDER-BOTTOM:
#000000 1pt solid; BACKGROUND-COLOR: #000000”>
                  <div>
                    <font
face=“Verdana” color=“#ffffff” size=“2”></font></div>
                  <div align=“center”>
                    <font
color=“#ffffff” size=“4”>
  <strong>MT ##IFG—MessageType—IFG## Message</strong>
                    </font>
                  </div>
                </td>
                <td style=“BORDER-RIGHT:
#000000 1pt solid; BORDER-TOP: #000000 1pt solid; BORDER-LEFT: #000000 1pt solid; BORDER-BOTTOM:
#000000 1pt solid; BACKGROUND-COLOR: #ffffff”>
                  <div>
                    <font
face=“Verdana” size=“2”>
                      <img
style=“WIDTH: 199px; HEIGHT: 60px” height=“135” src=“customerlogo.gif” width=“448”/>
                    </font>
                  </div>
                </td>
              </tr>
              <tr style=“MIN-HEIGHT: 19px”>
                <td colSpan=“3” style=“BORDER-
RIGHT: #000000 1pt solid; BORDER-TOP: #000000 1pt solid; BORDER-LEFT: #000000 1pt solid; BORDER-
BOTTOM: #000000 1pt solid; BACKGROUND-COLOR: #ffffff”>
                  <div>
                    <font
face=“Verdana” size=“2”></font> </div>
                  <div>
  <strong>Category ##IFG—Category—IFG##:</strong>
                  </div>
                  <div><xsl:apply-
templates select=“ModifiedMessage/ns0:##IFG—DocumentSchemaRootNodeName—IFG##/SWIFTHeader”
mode=“_headerP”/>
                  </div>
                </td>
              </tr>
              <tr style=“MIN-HEIGHT: 19px”>
                <td colSpan=“3” style=“BORDER-
RIGHT: #000000 1pt solid; BORDER-TOP: #000000 1pt solid; BORDER-LEFT: #000000 1pt solid; BORDER-
BOTTOM: #000000 1pt solid; BACKGROUND-COLOR: #ffffff”>
                  <div><xsl:apply-
templates
select=“ModifiedMessage/ns0:##IFG—DocumentSchemaRootNodeName—IFG##/##IFG—DocumentSchemaBody
NodeName—IFG##” mode=“_bodyP”/>
                  </div>
                </td>
              </tr>
              <tr style=“MIN-HEIGHT: 20px”>
                <td colSpan=“3” style=“BORDER-
RIGHT: #000000 1pt solid; BORDER-TOP: #000000 1pt solid; BORDER-LEFT: #000000 1pt solid; BORDER-
BOTTOM: #000000 1pt solid; BACKGROUND-COLOR: #ffffff”>
                  <div><xsl:apply-
templates select=“ModifiedMessage/ns0:##IFG—DocumentSchemaRootNodeName—FG##/SWIFTTrailer”
mode=“_trailerP”/>
                  </div>
                </td>
              </tr>
            </tbody>
          </table>
        </div>
      </body>
    </html>
  </xsl:template>
  ##IFG—View—IFG##
  <xsl:template match=“SWIFTHeader” mode=“_headerP”>
    <div class=“xdSection xdRepeating” title=“” style=“MARGIN-BOTTOM: 6px; WIDTH: 100%”
align=“left” xd:CtrlId=“CTRL588” xd:xctname=“Section” tabIndex=“−1”>
      <div>This is Interchange header</div>
      <div> </div>
      <div><xsl:apply-templates select=“BasicHeaderBlock” mode=“_109”/>
      </div>
    </div>
  </xsl:template>
  <xsl:template match=“BasicHeaderBlock” mode=“_109”>
    <div class=“xdSection xdRepeating” title=“” style=“MARGIN-BOTTOM: 6px; WIDTH: 100%”
align=“left” xd:CtrlId=“CTRL247” xd:xctname=“Section” tabIndex=“−1”>
      <div>
        <font size=“3”>
          <strong>Basic Header Block:</strong>
        </font>
      </div>
      <div>Application Identifier: <select class=“xdComboBox xdBehavior_Select” title=“”
size=“1” tabIndex=“0” xd:CtrlId=“CTRL248” xd:xctname=“DropDown” xd:binding=“ApplicationIdentifier”
xd:boundProp=“value” style=“WIDTH: 260px”>
          <xsl:attribute name=“value”>
            <xsl:value-of select=“ApplicationIdentifier”/>
          </xsl:attribute>
          <option>
            <xsl:if test=“ApplicationIdentifier=&quot;&quot;”>
              <xsl:attribute
name=“selected”>selected</xsl:attribute>
            </xsl:if>Select...</option>
          <option value=“F”>
            <xsl:if test=“ApplicationIdentifier=&quot;F&quot:”>
              <xsl:attribute
name=“selected”>selected</xsl:attribute>
            </xsl:if>F</option>
          <option value=“G”>
            <xsl:if test=“ApplicationIdentifier=&quot;G&quot;”>
              <xsl:attribute
name=“selected”>selected</xsl:attribute>
            </xsl:if>G</option>
        </select>
      </div>
      <div>Service Identifier: <span class=“xdTextBox ” hideFocus=“1” title=“”
contentEditable=“true” tabIndex=“0” xd:Ctrlid=“CTRL249” xd:xctname=“PlainText” xd:binding=“ServiceIdentifier”
style=“WIDTH: 260px; WHITE-SPACE: nowrap; WORD-WRAP: normal”>
          <xsl:value-of select=“ServiceIdentifier”/>
        </span>
      </div>
      <div>LTAddress: <span class=“xdTextBox” hideFocus=“1” title=“”
contentEditable=“true” tabIndex=“0” xd:CtrlId=“CTRL250” xd:xctname=“PlainText” xd:binding=“LTAddress”
style=“WIDTH: 260px; WHITE-SPACE: nowrap; WORD-WRAP: normal”>
          <xsl:value-of select=“LTAddress”/>
        </span>
      </div>
    <div>Session Number: <span class=“xdTextBox” hideFocus=“1” title=“” tabIndex=“−1”
xd:CtrlId=“CTRL592” xd:xctname=“PlainText” xd:binding=“SessionNumber” xd:disableEditing=“yes” style=“WIDTH:
260px; WHITE-SPACE: nowrap; WORD-WRAP: normal”>
          <xsl:value-of select=“SessionNumber”/>
        </span>
      </div>
      <div>Sequence Number: <span class=“xdTextBox” hideFocus=“1” title=“” tabIndex=“−
1” xd:CtrlId=“CTRL594” xd:xctname=“PlainText” xd:binding=“SequenceNumber” xd:disableEditing=“yes”
style=“WIDTH: 260px; WHITE-SPACE: nowrap; WORD-WRAP: normal”>
          <xsl:value-of select=“SequenceNumber”/>
        </span>
      </div>
    </div>
  </xsl:template>
  <xsl:template match=“SWIFTTrailer” mode=“_trailerP”>
    <div class=“xdSection xdRepeating” title=“” style=“MARGIN-BOTTOM: 6px; WIDTH: 100%”
align=“left” xd:CtrlId=“CTRL589” xd:xctname=“Section” tabIndex=“−1”>
      <div>This is Interchange trailer</div>
      <div> </div>
      <div><xsl:apply-templates select=“EndTextBlock” mode=“_168”/>
      </div>
      <div/>
    </div>
  </xsl:template>
  <xsl:template match=“EndTextBlock” mode=“_168”>
    <xsl:if test=“not((not(EndTextBlock)))”>
      <div class=“xdSection xdRepeating” title=“” style=“MARGIN-BOTTOM: 6px; WIDTH:
100%” align=“left” xd:CtrlId=“CTRL378” xd:xctname=“Section” tabIndex=“−1”>
        <div>End Text Block: <span class=“xdTextBox” hideFocus=“1” title=“”
contentEditable=“true” tabIndex=“0” xd:CtrlId=“CTRL379” xd:xctname=“PlainText” xd:binding=“EndTextBlock”
style=“WIDTH: 260px; WHITE-SPACE: nowrap; WORD-WRAP: normal”>
            <xsl:value-of select=“EndTextBlock”/>
          </span>
        </div>
      </div>
    </xsl:if>
  </xsl:template>
</xsl:stylesheet>
```

What is claimed is:

1. A system that facilitates automatic generation of a user interface form(s) comprising:
a normalizer component that normalizes a schema into a hierarchy of objects containing complex schema nodes; and
a mapping component that maps the complex schema nodes to user interface control(s), to facilitate automatic form generation.

2. The system of claim 1 further comprising an XML Schema Definition (XSD) divisible to a plurality of nodes that include a Complex node, a Choice node, a simple node and an Enumeration node.

3. The system of claim 1, the user interface form with files generated from at least one of a static and dynamic template.

4. The system of claim 3, the dynamic template further comprises a micro-template that contains a name of the schema.

5. The system of claim 4, the micro-template contains a value that is replaceable in the dynamic template.

6. The system of claim 2 further comprising a palette of user interface (UI) controls with the plurality of nodes mapable thereto.

7. The system of claim 6, the Complex node mapped to a complex element in the XML schema.

8. The system of claim 6, the Choice node mapped to a Choice node in the schema.

9. The system of claim 7 further comprising an abstract generation language generated by UI nodes.

10. A method of automatically generating user interface forms comprising:
normalizing a document schema into a hierarchy of objects;
mapping data nodes to UI controls; and
generating an abstract presentation language from the UI controls.

11. The method of claim 10 further comprising employing the abstract presentation language for at least one of a repairing a message and approving the message.

12. The method of claim 11 further comprising employing the abstract presentation language for at least one of a verifying a message that has been repaired and entering a message.

13. The method of claim 12 further comprising collecting validation errors and saving in a canonical format.

14. The method of claim 12 further comprising breaking a schema to a plurality of nodes that include a Complex node, a Choice node, a Simple node, and an Enumeration node.

15. The method of claim 14 further comprising mapping the Complex node to a complex element associated with the document schema.

16. The method of claim 14 further comprising mapping a Choice node to a choice node in the schema.

17. The method of claim 14 further comprising mapping the Simple node to a leaf level node in the schema that is not an enumeration.

18. The method of claim 14 further comprising mapping an Enumeration node to a leaf level node that is an enumeration.

19. The method of claim 14 further comprising building an object model on the schema.

20. A system that facilitates automatic generation of user interface forms comprising:
means for normalizing a schema into a hierarchy of objects containing complex schema nodes; and
means for mapping the complex schema nodes to user interface controls, to facilitate automatic form generation.
